(19) United States
(12) Patent Application Publication
(10) Pub. No.: US 2006/0068365 A1
(43) Pub. Date: Mar. 30, 2006

(54) Vision training system

(76) Inventor: Kirby Smith, Barrington, IL (US)

Correspondence Address: HAMRE, SCHUMANN, MUELLER & LARSON, P.C., P.O. BOX 2902-0902, MINNEAPOLIS, MN, 55402, US

(21) Appl. No.: 11/209,002

(22) Filed: Aug. 22, 2005

Related U.S. Application Data
(60) Provisional application No. 60/609,090, filed on Sep. 9, 2004.

(51) Int. Cl. G09B 9/02

(52) U.S. Cl. 434/29; 463/49; 434/30

(57) ABSTRACT

The disclosure relates to a training method for improving coordination by gradually increasing an individual's ability to track objects. The training method includes providing an apparatus for propelling objects in a direction towards a participant; varying the speed and trajectory of the projectiles; monitoring the participant's ability to track the projected objects; adjusting the speed and trajectory to the projectiles according to the particular needs of the participant.

### REFERENCE TO RELATED APPLICATIONS

This application claims priority to provisional application Ser. No. 60/609,090 filed Sep. 9, 2004.

### TECHNICAL FIELD

This present disclosure relates to a training method that improves one's motor skills. In particular, the method improves one's ability to visually track a moving object.

### BACKGROUND

In tracking a projected object, such as a ball, the participant aims to maintain fixation on the object with his or her fovea, the region of the retina with the greatest visual acuity. In tracking moving objects the participant utilizes mainly three movements. First, the participant's eyes adjust via “saccadic eye movements,” which enable the participant to switch from a wide field of focus to a fine field of focus (such as the release point of the object). Second, the participant uses “smooth-pursuit eye movements” to track an object in its trajectory from the release point to the point of interception. Optionally, a hitter can also use “saccadic eye movements,” to track the object. If the participant uses “saccadic eye movements,” the participant's vision moves or transfers ahead of the object to the point of contact. When using “saccadic eye movements,” to track an object, the hitter uses peripheral vision to follow the object while focusing on the contact point. Vestibulo-ocular eye movements compensate for head movements as the “gaze angle” gradually increases (the gaze angel exists as the angle between the line of sight pointing to the release point of the object and the line of sight to the object).

A strategy for tracking a moving object is to follow the object with smooth-pursuit eye movement (including modest head movement) to the last possible instant, thereby allowing the participant to make a more accurate prediction or estimate of the impact point. In order to improve the participant's head-eye coordination to better make contact with a propelled projectile, one's “smooth-pursuit eye movements” must be conditioned to be faster and one's “vestibule-ocular” reflex must be suppressed. Improved training techniques in this area are needed.

### SUMMARY

The present process is used to condition visual focus to improve coordination with a participant's motor skills. The training method can gradually increase a participant's gaze angle in tracking objects, thereby improving the participant's tracking abilities. The training technique can, among other things, improve one's ability to better intercept a moving object propelled at varying speeds and projected to different finite areas.

The process includes providing an apparatus for propelling an object towards a participant; varying the speed and/or trajectory of the projectiles; analyzing the participant's ability to track the projected objects; adjusting the speed and/or trajectory to the projectiles to hone participant's overall tracking abilities.

### DESCRIPTION OF THE DRAWINGS

FIG. 1 is a block diagram illustrating a method for training and testing visual focus according to the present invention;

FIG. 2 is a diagrammatic illustration of the various zones that objects are projected through for training and testing; and

FIG. 3 is a diagrammatic top view showing the gaze angle according to the present invention.

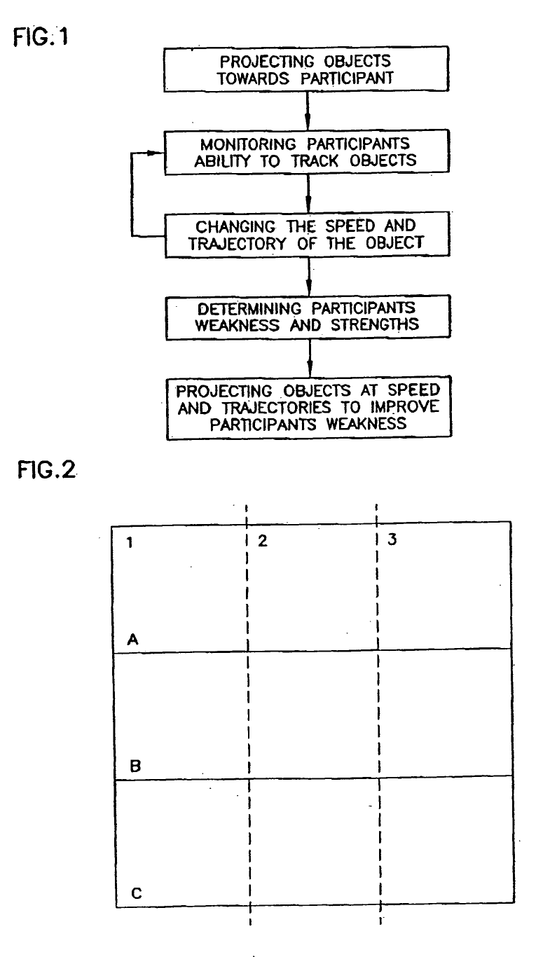

### DETAILED DESCRIPTION

Referring to FIG. 3, according to one embodiment of the invention, each training session begins with a participant 7, for example, an athlete, soldier, or other participant, merely observing between 30-40 projectiles 8 propelled from the machine 9.

In one embodiment tennis balls are used as projectiles 8 for training. The projectiles 8 can be pre-marked at the discretion of the instructor. For example, the projectiles 8 can be color-coded, numbered or lettered. The participant 7 first attempts to read or recognize such symbols for the instructor as they pass from the machine 9 in their trajectories 10 to, through, and beyond the anticipated point of intercept to a gaze angle 6 of close to 100 degrees. Changing the size of the markings on the projectiles 8 can further advance this exercise.

The participant 7 may then attempt to contact the projectile 8 for training. In some embodiments a bat, rod, racquet, or stick is used. For example, a bat can be positioned on the participant's back hip, pointing it generally straight out over a plate. The participant 7 is “taking” to contact rather than swinging. The participant 7 attempts to track the object propelled from the machine 9 to the point of impact with the bat, thus moving the head “shoulder to shoulder” as the participant 7 tracks the ball. This exercise forces the participant 7 to track the object to a gaze angle 6 of approximately 90 degrees from the release point of the machine 9 to impact with the at the point of intercept. The participant's recognition of images or color-coding on the objects can be critiqued or recorded by the instructor during this part of the exercise.

In some embodiments the “taking” step does not involve physically contacting the projectile 8. In such embodiments the participant 7 follows the object from the release point to near the participant 7. The point near the participant 7 can be, for example, the back tip of home plate or a catcher's glove.

After a pause, the participant 7 may resume the training session by swinging at (rather than “taking”) the propelled object for approximately 40 repetitions. At this point during the contact phase the hips and shoulders would rotate toward the release point of the machine 9. As shoulder-to-shoulder tracking takes place, the head and eyes counter-rotate to the contact point. The objects can be projected at different locations within the entire area in which the point of intercept will occur at velocities slightly faster or slower than those typically encountered under non-training conditions. Velocity progression would be from medium-to-slow to medium-to-fast to arbitrary.

During the above-described training steps, an instructor can study the participant's head and eyes as the object approaches the point of intercept. During these repetitions the instructor can observe and document specific, individual techniques and body mechanics of the participant 7. In some embodiments the trainer observes a participant's areas of tracking strength as well as blind spots and areas of poor recognition or tracking weaknesses using video, still photos, and charts. The instructor can address and discuss these observations with the participant 7. This training session exposes a participant's areas of tracking weaknesses and highlights a participant's areas of tracking success. It also allows the instructor to evaluate the participant's ability to track the ball to his maximum gaze angle 6 to the intersection of the gaze angle 6 with the path of the ball and the trajectory of the object 10 to the point of intercept.

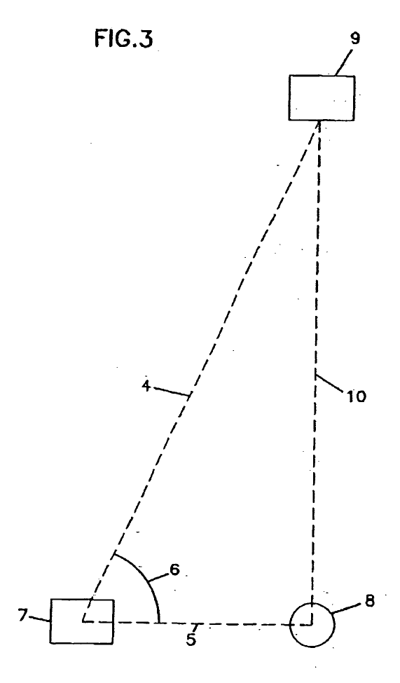

Referring to FIG. 2, after the foregoing observations are made by the instructor and discussed with the participant 7, the instructor may fine-tune the locations at which the objects are projected among all of the areas in which the object could be impacted. This fine-tuning focuses on the participant's areas of weakness. In some embodiments objects are first projected at a constant velocity to the center portions of those distinct areas in which the point of intercept typically occurs during competition. The trajectory of the objects can be adjusted from such center points within the typical impact area to the outer points thereof and from the upper points to those lower points within the typical impact area. Thus, by adjusting the trajectories of the propelled objects to distinct, targeted points within the typical impact area, the instructor can monitor and better evaluate the participant's areas of tracking strength and areas of tracking weaknesses in making impact with the object at the point of intercept.

FIG. 2 illustrates some of the various zones or areas in which the projectile 8 can be directed. In certain context the entire area is referred to as the strike zone. The inner half, or inner zone, 1 is the area nearest the participant 7. The outer half, or outer zone, 3 is the area further from the participant 7. Down the middle, or center zone, 2 is the area between the inner half 1 and outer half 3. Each of the above zones or areas is further divided into an upper portion A, a middle portion B, and a lower portion C. As shown, the area is divided into nine zones. Contact characteristics can vary from zone to zone. For example, contact occurs sooner in the inner half 1 than in the outer half 3. It should be appreciated that in some embodiments there are fewer or greater number of zones. For example in an alternative embodiment there are six zones instead of nine zones because the vertical zones are divided into two sections (upper and lower) instead of three sections as shown in FIG. 2.

When areas of tracking are separated in the above manner, the instructor can decrease the velocity of the objects directed to those areas or zones of tracking weakness to a velocity where the participant's angle gaze and shoulder-to-shoulder movement improve enough for the participant 7 to achieve greater and more regular success in making contact with the object 8. When tracking success results from such conditioning exercises in a given area of former weakness, the velocity of the objects 8 can be gradually increased to further condition and train the participant 7 to better track the objects 8 directed to those same targeted areas in order to achieve an even greater gaze angle 6. This conditioning is continued until the participant 7 is better able to achieve success at making impact at velocities equal to or greater than those typically encountered.

The disclosed training systems can be incorporated into training for a variety of sports where an object travels at high velocities and must be struck, caught, or blocked. Most notably, baseball and softball participants would benefit from such a system of visual training. In addition, participants from a wide range of sports that require effectively tracking a projected object (such as tennis, football, and hockey) would benefit from such training.

An apparatus or machine 9 for projecting objects 8 with accuracy is central to the above-described process of visual development and conditioning. One suitable apparatus is called the “Flame Thrower.” The subject pneumatic machine uses compressed air to propel an object towards a participant 7. While doing so, its design permits an instructor to change both velocity and location to a precise, pre-determined point (such as “inside,” “outside,” or “down the middle” and each of those “high,” “middle,” or “low”). The machine propels objects at velocities ranging from 60 mph to 140 mph. It should be understood that additional equipment, such as wheel-based ATEC or JUGS machines, which project objects of greater or lesser weights can be used.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A visual training method including the steps of:
providing a machine for projecting objects at various trajectories and speeds;
projecting the objects generally towards a participant;
varying the speed and trajectory of the objects;
determining the participant's tracking abilities; and
adjusting the speed and trajectory of the objects based upon the participant's tracking abilities.

2. The visual training method of claim 1, wherein the projectiles are projected at a slower speed in a first zone and a faster speed in a second zone, wherein the first zone corresponds to a relative tracking weakness of the participant and the second zone corresponds to a relative tracking strength of the participant.

3. The visual training method of claim 1, the step of determining the participant's tracking strengths and weaknesses includes instructor critique, video recording, or stop action photos of the participant while the participant visually tracks objects projected from the machine.

4. The visual training method of claim 1, wherein the step of determining the participant's tracking abilities by analyzing the participant's body movement and the body position while the participant tracks projected objects.

5. The visual training method of claim 4, further including the step of monitoring the participant's head and eye movements.

6. The visual training method of claim 1, wherein the participant's tracking abilities within a predefined area that is located adjacent to a participant and oriented generally perpendicular to the trajectory of the projected objects are determined.

7. The visual training method of claim 6, wherein the predefined area includes at least two zones.

8. The visual training method of claim 7, wherein the predefined area includes six zones: an inner upper zone, an inner lower zone, a middle upper zone, a middle lower zone, an outer upper zone, and an outer lower zone.

9. The visual training method of claim 7, wherein the predefined area includes nine zones: an inner upper zone, an inner center, an inner lower zone, a middle upper zone, a middle center, a middle lower zone, an outer upper zone, an outer center, and an outer lower zone.

10. The visual training method of claim 7, wherein a target speed of the projected object in each zone depends on the participant's tracking abilities in the respective zone.

11. The visual training method of claim 1, wherein the participant attempts to move a prop into the path of the projected objects to contact the projected objects.

12. The visual training method of claim 11, where the participant swings a prop at the projected objects.

13. The visual training method of claim 11, wherein the prop includes a bat and projected objects include a ball.

14. The visual training method of claim 11, wherein the prop includes a racket.

15. The visual training method of claim 1, wherein the objects are marked for visual identification by the participant.

16. The visual training method of claim 15, wherein determining the participant's tracking abilities includes measuring the participant's ability to identify markings on the projected objects at various speeds.

17. The visual training method of claim 11, wherein determining the participant's tracking abilities includes measuring the participant's tracking abilities includes measuring the participant's ability to contact the projected objects with the prop.

18. The visual training method of claim 7, wherein the speed of the projected objects in each zone is increased as the participant's tracking ability improves.

19. The visual training of claim 7, wherein the trajectory of the projected objects in each zone is varied according to the participant's tracking abilities.
